(19) United States
(12) Patent Application Publication
(10) Pub. No.: US 2018/0152237 A1
(43) Pub. Date: May 31, 2018

(54) TRANSMISSION DEVICE AND PATH SWITCHING METHOD

(71) Applicant: FUJITSU LIMITED, Kawasaki-shi (JP)

(72) Inventors: Hiroyuki NISHIMURA, Kawasaki (JP); HIDEO ABE, Oyama (JP)

(73) Assignee: FUJITSU LIMITED, Kawasaki-shi (JP)

(21) Appl. No.: 15/805,723

(22) Filed: Nov. 7, 2017

(30) Foreign Application Priority Data
Nov. 25, 2016 (JP) 2016-229500

(51) Int. Cl. H04B 10/032; H04Q 11/00

(52) U.S. Cl. CPC H04B 10/032; H04Q 2011/0043; H04Q 11/0005

(57) ABSTRACT

There is provided a transmission device including a hardware processor configured to receive an alarm for each of paths, and generate an interrupt request, when a series of alarms is received at a time interval equal to or less than a predetermined value and a last alarm of the series of alarms is received, a memory, and a processor coupled to the memory and the processor configured to switch the path, provided on a transmission line in an active system and from which the alarm is received, from the active system to a standby system in response to the interrupt request generated by the hardware processor.

### CROSS-REFERENCE TO RELATED APPLICATION

This application is based upon and claims the benefit of priority of the prior Japanese Patent Application No. 2016-229500, filed on Nov. 25, 2016, the entire contents of which are incorporated herein by reference.

### FIELD

The embodiments discussed herein are related to a transmission device and a path switching method.

### BACKGROUND

When a failure occurs in a communication path of an active system (hereinafter referred to as an “active path”), a transmission device switches the active path to a communication path of a standby system (hereinafter referred to as a “standby path”) so as to continue the communication (see, e.g., Japanese Laid-Open Patent Publication No. 2001-186137). Since a number (e.g., 100 or more) of logical communication paths (hereinafter referred to as “logical paths”) are set in a physical communication line (hereinafter referred to as a “physical line”) such as an optical fiber, when a failure occurs in the physical line, a number of alarms are detected in the transmission device.

In order to perform a path switching, the transmission device issues an interrupt request (IRQ) to a processor such as a central processing unit (CPU) based on each alarm. In connection with an interrupt request, for example, International Publication Pamphlet No. WO 2015/173853 discloses a technique for reducing the number of interrupt notifications that notifies completion of execution of input/output instructions.

Related technologies are disclosed in, for example, Japanese Laid-Open Patent Publication No. 2001-186137 and International Publication Pamphlet No. WO 2015/173853.

### SUMMARY

According to an aspect of the invention, a transmission device includes a hardware processor configured to receive an alarm for each of paths, and generate an interrupt request, when a series of alarms is received at a time interval equal to or less than a predetermined value and a last alarm of the series of alarms is received, a memory, and a processor coupled to the memory and the processor configured to switch the path, provided on a transmission line in an active system and from which the alarm is received, from the active system to a standby system in response to the interrupt request generated by the hardware processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a network;

FIG. 2 is a configuration diagram illustrating an example of a layer 2 switch;

FIG. 3 is a configuration diagram illustrating another example of the layer 2 switch;

FIG. 4 is a diagram illustrating a configuration related to path switching in a first comparative example;

FIG. 5 is a flowchart illustrating a path switching operation in the first comparative example;

FIG. 6 is a sequence diagram illustrating a path switching operation when there are many alarms, in the first comparative example;

FIG. 7 is a sequence diagram illustrating a path switching operation when there are a few alarms, in the first comparative example;

FIG. 8 is a diagram illustrating a configuration related to path switching in a second comparative example;

FIG. 9 is a flowchart illustrating a path switching operation in the second comparative example;

FIG. 10 is a diagram illustrating a configuration related to path switching in a third comparative example;

FIG. 11 is a flowchart illustrating a path switching operation in the third comparative example;

FIG. 12 is a diagram illustrating a configuration related to path switching in a first embodiment;

FIG. 13 is a flowchart illustrating a path switching operation in the first embodiment;

FIG. 14 is a sequence diagram illustrating a path switching operation in the first embodiment;

FIG. 15 is a diagram illustrating a configuration related to path switching in a second embodiment;

FIG. 16 is a flowchart illustrating a path switching operation in the second embodiment; and

FIG. 17 is a sequence diagram illustrating a path switching operation in the second embodiment.

### DESCRIPTION OF EMBODIMENTS

Upon receiving an interrupt request, in order to suspend a process being executed, a processor temporarily saves, for example, various variables related to the status of the process in a predetermined area of a memory. When such an overhead process is executed each time an alarm is received, since the processing load of the processor increases, the time required for path switching may extend and the path switching within the required time may become impossible.

Hereinafter, embodiments of a technique capable of reducing the load of a path switching process of a processor will be described with reference to the accompanying drawings.

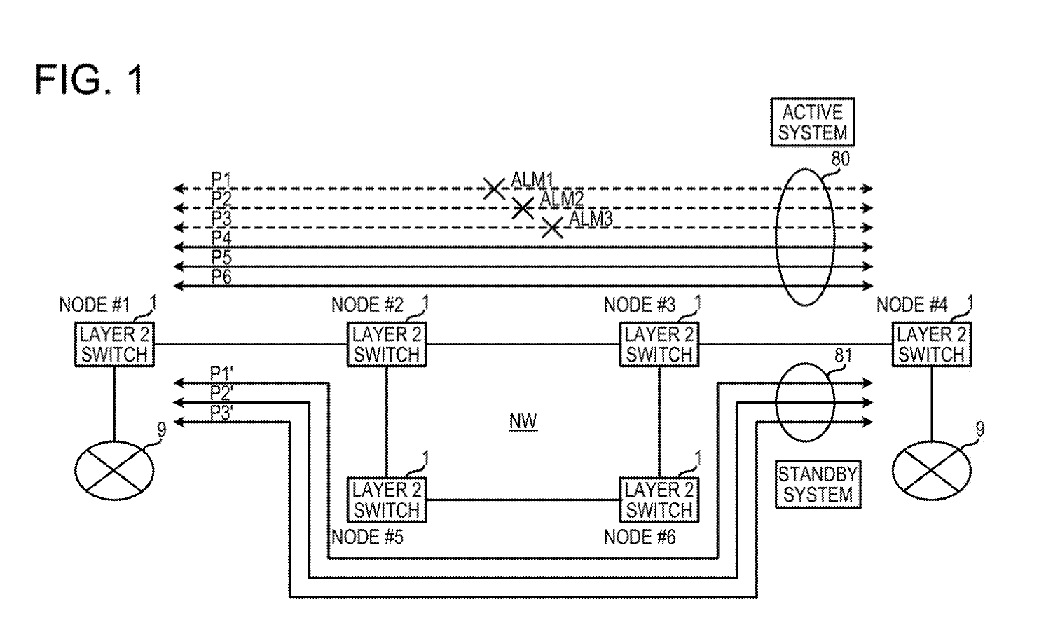

FIG. 1 is a configuration diagram illustrating an example of a network NW. As for an example, the network NW includes a plurality of interconnected nodes #1 to #6, each of which has a layer 2 switch 1 as an example of a transmission device and transmits a packet to a route corresponding to its destination. The packet may be in the form of, for example, an Ethernet® frame, but the form of the packet may not be limited thereto.

The nodes #1 to #4 are connected in series in this order, the node #5 is connected to the node #2, and the node #6 is connected to the node #3, through transmission lines. Further, the node #5 and the node #6 are connected to each other through transmission lines.

The layer 2 switches 1 of the node #1 and the node #4 are connected to their respective client networks 9. The layer 2 switches 1 of the node #1 and the node #4 transmit packets between the different client networks 9.

Logical paths P1 to P6 of an active system are set between the node #1 and the node #4. The logical paths P1 to P6 pass through the node #1, the node #2, the node #3, and the node #4 and are provided on a physical line 80.

In addition, logical paths P1′ to P3′ of a standby system, which correspond respectively to the logical paths P1 to P3 of the active system, are set between the node #1 and the node #4. The logical paths P1′ to P3′ pass through the nodes #1 to #4 so as to bypass the logical paths P1 to P6 and are provided on a physical line 81. In this manner, the communication paths between the node #1 and the node #4 are redundantly formed. Examples of the physical lines 80 and 81 may include transmission lines such as optical fibers.

The logical paths P1 to P6 and P1′ to P3′ are respectively set as, for example, a virtual local area network (VLAN) and are identified by a VLAN identifier (VID). Each layer 2 switch 1 receives an alarm for each of the logical paths P1 to P6 and P1′ to P3′.

For example, upon receiving alarms ALM1 to ALM3 of the logical paths P1 to P3 of the active system, each layer 2 switch 1 stops the communication by the logical paths P1 to P3 corresponding respectively to the alarms ALM1 to ALM3, and initiates the communication by the logical paths P1′ to P3′. In this way, in response to receiving the alarms ALM1 to ALM3, each layer 2 switch 1 performs switching from the active system to the standby system for each of the logical paths P1 to P6 and P1′ to P3′ provided on the physical lines 80 and 81. Although not illustrated, this path switching is equally applied to the logical paths P4 to P6 of the active system.

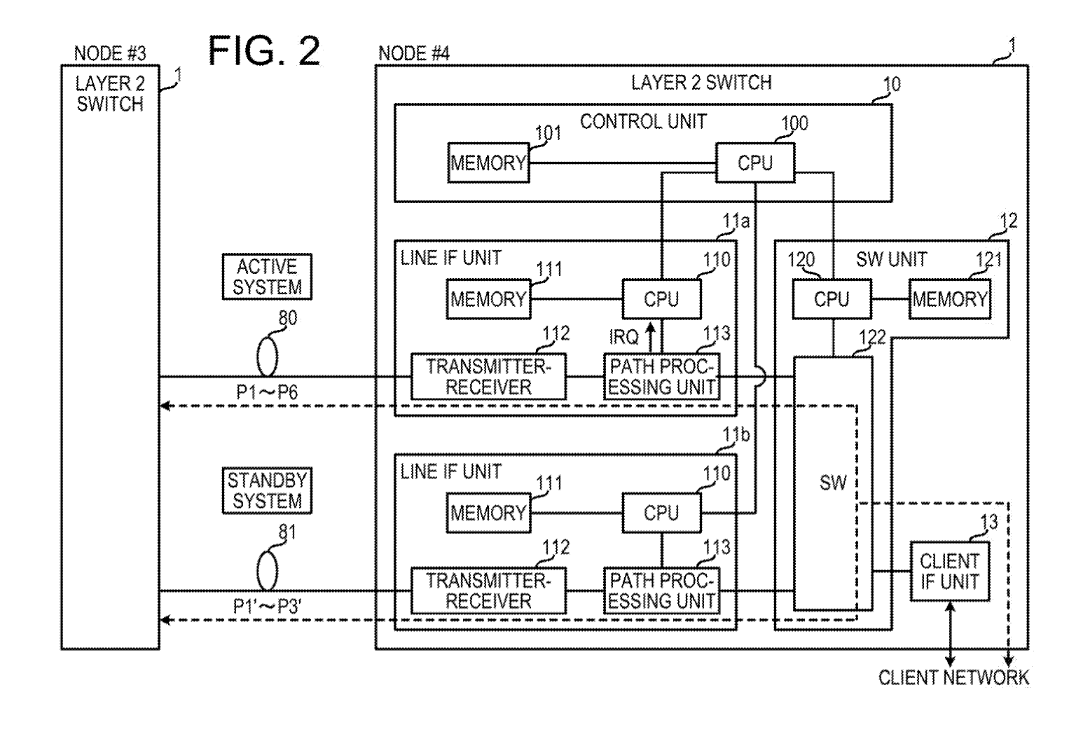

FIG. 2 is a configuration diagram illustrating an example of a layer 2 switch 1. FIG. 2 illustrates layer 2 switches 1 of a set of adjacent nodes #3 and #4. The layer 2 switches 1 of the node #3 and #4 have the same configuration and therefore, only the configuration of the layer 2 switch 1 of one node #4 is illustrated.

The layer 2 switches 1 of the nodes are connected to each other by a physical line (optical fiber) 80 of the active system and a physical line 81 of the standby system. The physical line 80 is used for communication of logical paths (active paths) P1 to P6 of the active system and the physical line 81 is used for communication of logical paths (standby paths) P1′ to P3′ of the standby system. Although not illustrated, the physical lines 80 and 81 are separately provided for each of the transmission direction and the reception direction of the layer 2 switch 1.

Each layer 2 switch 1 includes a control unit 10, line interface units (line IF units) 11a and 11b, a switch unit (SW unit) 12, and a client interface unit (client IF unit) 13.

The line IF units 11a and 11b process communication by a communication line with another layer 2 switch 1. The line IF unit 11a is connected to the physical line 80 of the active system and the line IF unit 11b is connected to the physical line 81 of the standby system. Therefore, the line IF unit 11a processes communication of the active paths P1 to P6 and the line IF unit 11b processes communication of the standby paths P1′ to P3′.

The layer 2 switch 1 performs communication using the active paths P1 to P6. As described above, when a failure occurs in the active paths P1 to P3, the layer 2 switch 1 performs communication using the standby paths P1′ to P3′. That is, in response to a failure of an active path being used, the layer 2 switch 1 switches the active path to a standby path.

The client IF unit 13 processes communication with a client network 9. For example, the client IF unit 13 converts a packet format and a transmission rate with the client network 9.

The SW unit 12 exchanges packets between the line IF units 11a and 11b and the client IF unit 13. For example, upon receiving a packet, which is addressed to the client network 9, from the layer 2 switch 1 of the adjacent node #3 via the line IF unit 11a, the SW unit 12 transmits the packet to the client IF unit 13. Further, upon receiving a packet, which is addressed to the client network 9 connected to the layer 2 switch 1 of the node #1, via the client IF unit 13, the SW unit 12 transmits the packet to the line IF unit 11a.

The control unit 10 monitors and controls the line IF units 11a and 11b, the SW unit 12, and the client IF unit 13. Communication by, for example, Ethernet is performed between the control unit 10 and the line IF units 11a and 11b, the SW unit 12 and the client IF unit 13.

The control unit 10, the line IF units 11a and 11b, the SW unit 12, and the client IF unit 13 are formed by, for example, a circuit board on which a plurality of electric components are mounted, and are mounted in a slot provided in a housing of the layer 2 switch 1. The control unit 10, the line IF units 11a and 11b, the SW unit 12, and the client IF unit 13 are connected to a wiring board provided in the layer 2 switch 1 via an electrical connector and the like, and input/output signals to/from each other via the wiring board.

The control unit 10 includes a CPU 100 and a memory 101. The CPU 100 operates according to a program stored in the memory 101. The CPU 100 communicates with the line IF units 11a and 11b, the SW unit 12, and the client IF unit 13 and executes a monitoring/controlling process.

Each of the line IF units 11a and 11b includes a CPU 110, a memory 111, a transmitter-receiver 112, and a path processing unit 113. The CPU 110 operates according to a program stored in the memory 111.

The transmitter-receiver 112 exchanges packets with the layer 2 switch 1 of the adjacent node #3 via the physical lines 80 and 81. The transmitter-receiver 112 includes, for example, a laser diode and a modulator for transmitting a packet, a photodiode and a demodulator for receiving the packet, and the like.

The path processing unit 113 is configured by, for example, a field programmable gate array (FPGA), an application specific integrated circuit (ASIC), or the like. The path processing unit 113 outputs a packet to be transmitted, to the transmitter-receiver 112 and a packet received from the transmitter-receiver 112 is input. Further, under the control of the CPU 110, the path processing unit 113 sets logical paths for the physical lines 80 and 81.

The SW unit 12 includes a CPU 120, a memory 121, and a switch device (SW) 122. The switch device 122 is configured by, for example, an FPGA, an ASIC, or the like. The switch device 122 exchanges packets between the line IF units 11a and 11b and the client IF unit 13. More specifically, the SW unit 12 outputs packets to the line IF units 11a and 11b and the client IF unit 13 according to the destinations based on settings.

The CPU 120 operates according to a program stored in the memory 121. In accordance with an instruction from the CPU 100 of the control unit 10, the CPU 120 makes settings on packet exchanging for the switch device 122.

In the line IF unit 11a, the path processing unit 113 detects an alarm by receiving a monitoring packet of an active path from the physical line 80. The monitoring packet is, for example, a packet transmitted/received at a specific period to/from the layer 2 switch 1 of the adjacent node #3. The path processing unit 113 uses the monitoring packet to detect, for example, an alarm of degradation or disconnection of the physical line 80. The alarm is detected for each logical path. Since a number of (e.g., 100) logical paths are set in the active path, when a failure such as disconnection of the physical line 80 occurs, a large number of alarms are detected.

In this way, the path processing unit 113 uses the monitoring packet to detect an alarm of the active path. The path processing unit 113 outputs an IRQ to the CPU 110 based on the alarm. In response to the interrupt request, in cooperation with the CPU 100 of the control unit 10, the CPU 110 switches a logical path used in the layer 2 switch 1 from the active system to the standby system. More specifically, the CPUs 100, 110 and 120 execute a process of deleting the corresponding active path from the physical line 80 and setting a standby path on the physical line 81.

Accordingly, since the path of a packet is switched from the active path to the standby path, communication may be continued even if a failure occurs.

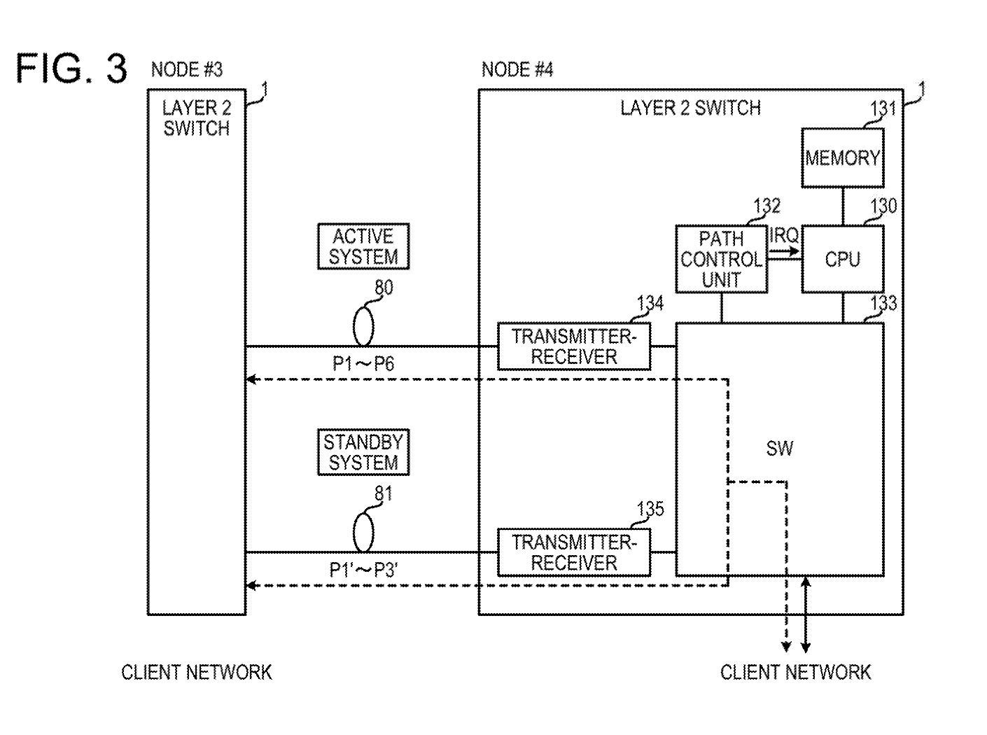

FIG. 3 is a configuration diagram illustrating another example of the layer 2 switch 1. FIG. 3 illustrates layer 2 switches 1 of a set of adjacent nodes #3 and #4. The layer 2 switches 1 of the node #3 and #4 have the same configuration and therefore, only the configuration of the layer 2 switch 1 of one node #4 is illustrated.

The layer 2 switches 1 of the nodes #3 and #4 are connected to each other by a physical line (optical fiber) 80 of the active system and a physical line 81 of the standby system. The physical line 80 is used for communication of active paths P1 to P6 and the physical line 81 is used for communication of standby paths P1′ to P3′. Although not illustrated, the physical lines 80 and 81 are separately provided for each of the transmission direction and the reception direction of the layer 2 switch 1.

Each layer 2 switch 1 includes a CPU 130, a memory 131, a switch device 133, a path control unit 132, and transceivers 134 and 135.

The transceivers 134 and 135 exchange packets with the layer 2 switch 1 of the adjacent node #3 via the physical lines 80 and 81, respectively. Each of the transceivers 134 and 135 includes, for example, a laser diode and a modulator for transmitting a packet, a photodiode and a demodulator for receiving the packet, and the like. The transceivers 134 and 135 transmit packets input from the switch device 133 and output received packets to the switch device 133.

The switch device 133 is constituted by, for example, an FPGA, an ASIC, or the like. The switch device 133 exchanges packets between another layer 2 switch 1 and the client network 9. More specifically, the switch device 133 transmits packets to another layer 2 switch 1 and the client network 9 according to the destinations based on settings.

The path control unit 132 is a hardware processor constituted by, for example, an FPGA, an ASIC, or the like. The path control unit 132 detects an alarm based on a monitoring packet received by the switch device 133. The path control unit 132 outputs an IRQ to the CPU 130 based on the alarm. The path control unit 132 and the switch device 133 are connected to the CPU 130 via a peripheral component interconnect express (PCIe) bus.

In response to the interrupt request, The CPU 130 switches a logical path used in the layer 2 switch 1 from the active system to the standby system. More specifically, for the switch device 133, the CPU 130 executes a process of deleting the corresponding active path from the physical line 80 and setting a standby path on the physical line 81.

Accordingly, since the path of a packet is switched from the active path to the standby path, communication may be continued even if a failure occurs.

In this manner, the layer 2 switch 1 switches a used logical path from the active path to the standby path by the CPUs 110 and 130.

### First Comparative Example

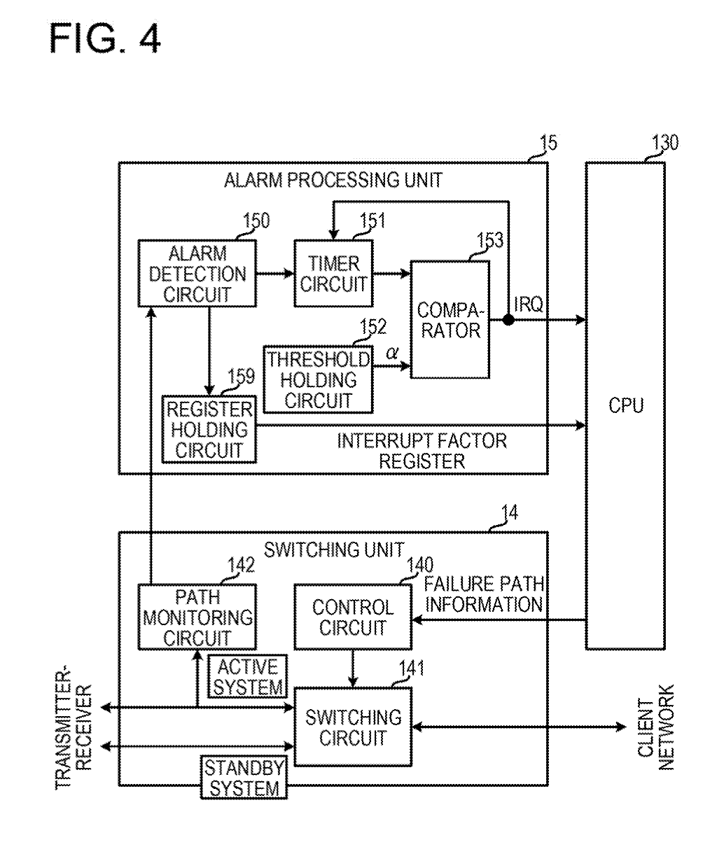

FIG. 4 is a diagram illustrating a configuration related to path switching in a first comparative example. In this example and the following examples, descriptions will be given based on the configuration illustrated in FIG. 3, but the configuration illustrated in FIG. 2 will also be described in the same manner.

A switching unit 14 is provided in the switch device 133 and includes a control circuit 140, a switching circuit 141, and a path monitoring circuit 142. The switching circuit 141 performs an operation of switching from the active path to the standby path under the control of the control circuit 140. The control circuit 140 receives failure path information from the CPU 130 and controls the switching circuit 141 to switch a logical path indicated by the failure path information to the standby path.

The switching circuit 141 is connected to the transceivers 134 and 135 and the client network 9. Typically, the switching circuit 141 transmits packets between the transceiver 134 of the physical line 80 of the active system and the client network 9. However, after switching to the standby system, the switching circuit 141 transmits packets between the transceiver 135 of the physical line 81 of the standby system and the client network 9. In the case of the configuration of FIG. 2, the switching circuit 141 and the control circuit 140 are provided in the switch device 122 of the SW unit 12.

The path monitoring circuit 142 receives a monitoring packet of the active path and acquires information on the status of the active path from the monitoring packet. The path monitoring circuit 142 outputs the acquired information to an alarm processing unit 15. In the case of the configuration of FIG. 2, the path monitoring circuit 142 is provided in the path processing unit 113 of the line IF unit 11a.

The alarm processing unit 15 is provided in the path control unit 132 and includes an alarm detection circuit 150, a timer circuit 151, a threshold holding circuit 152, a comparator 153, and a register holding circuit 159. In the case of the configuration of FIG. 2, the alarm processing unit 15 is provided in the path processing unit 113 of each of the line IF units 11a and 11b.

The alarm detection circuit 150 detects an alarm by receiving the information on the status of the active path from the path monitoring circuit 142. That is, the alarm processing unit 15 receives an alarm of the active path. The alarm detection circuit 150 holds, for example, information, such as a logical path corresponding to the alarm, as an interrupt factor register, in the register holding circuit 159. The register holding circuit 159 is composed of, for example, a nonvolatile memory or the like.

The alarm detection circuit 150 instructs the timer circuit 151 to start a timer that counts a predetermined time after detection of the first alarm out of alarms continuously occurring due to the same failure or a plurality of failures related to each other. The timer circuit 151 starts the timer according to the instruction from the alarm detection circuit 150 and outputs a timer value to the comparator 153. A preset threshold value α of the timer value is set in the threshold holding circuit 152. The comparator 153 reads from the threshold holding circuit 152 the threshold value α as a value at the expiration of the timer.

The comparator 153 compares the timer value input from the timer circuit 151 with the threshold value α read from the threshold holding circuit 152. As a result of the comparison, when the timer value does not match the threshold value α, the comparator 153 outputs a low level voltage signal to the CPU 130. When the timer value matches the threshold value α, the comparator 153 outputs a high level voltage signal, as an IRQ, to the CPU 130.

Upon receiving the interrupt request, the CPU 130 reads the interrupt factor register from the register holding circuit 159, generates failure path information based on the interrupt factor register, and outputs the generated failure path information to the control circuit 140. Accordingly, the switching circuit 141 performs setting of switching of the corresponding logical path to the standby path.

In this manner, upon receiving the interrupt request, the CPU 130 switches a logical path used in the layer 2 switch 1 from the active path to the standby path. That is, in response to the interrupt request, the CPU 130 switches from the active system to the standby system for each logical path provided on the physical line 80. Here, the interrupt request is an example of a request to the CPU 130 for switching to the standby path. In the case of the configuration of FIG. 2, instead of the CPU 130, the CPU 110 performs path switching processing. While the CPUs 130 and 110 are examples of processors, other processors such as network processors may be used.

A signal of the interrupt request is also input to the timer circuit 151. Upon receiving the interrupt request signal, the timer circuit 151 resets the timer value to 0. A path switching operation in the above-described configuration will be described below.

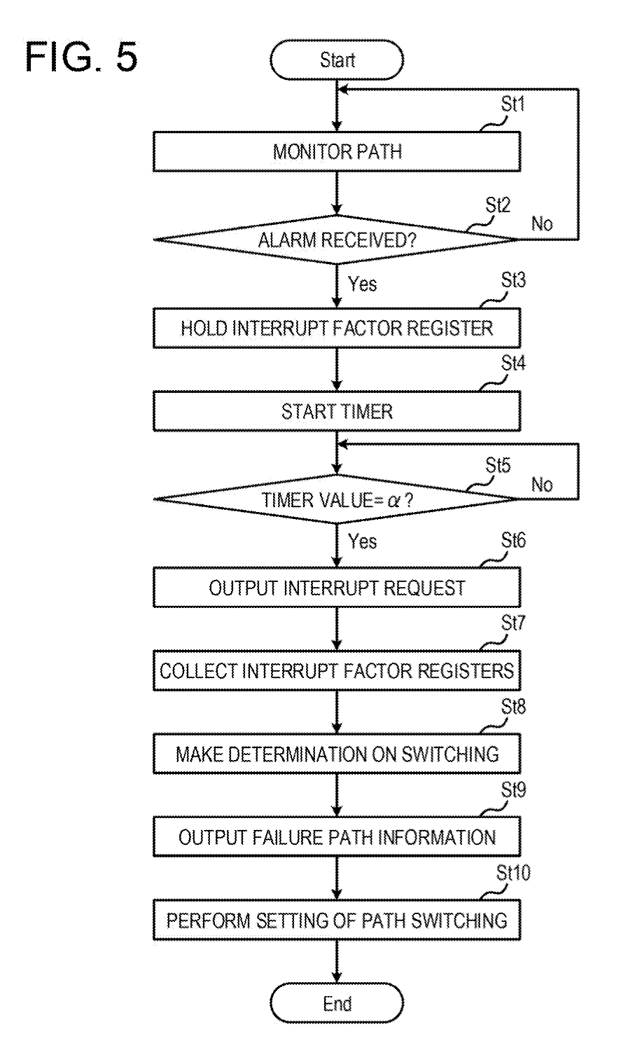

FIG. 5 is a flowchart illustrating a path switching operation in the first comparative example. The path monitoring circuit 142 monitors the active path based on a monitoring packet (Operation St1). The monitoring packet is identified by a unique pattern and notifies information on the status of each active path. The alarm detection circuit 150 detects an alarm by receiving this information from the path monitoring circuit 142. That is, the alarm detection circuit 150 receives an alarm of the active path from the path monitoring circuit 142.

The alarm detection circuit 150 determines whether or not an alarm is received (Operation St2). When it is determined that no alarm is received (“No” in Operation St2), the alarm detection circuit 150 executes the operation St1 again. When it is determined that an alarm is received (“Yes” in Operation St2), the alarm detection circuit 150 generates an interrupt factor register from the information received from the path monitoring circuit 142 and holds the interrupt factor register in the register holding circuit 159 (Operation St3).

Next, the alarm detection circuit 150 instructs the timer circuit 151 to start a timer that counts the time of the threshold value α (Operation St4). The timer circuit 151 starts the timer according to the instruction from the alarm detection circuit 150 (Operation St4).

Next, the comparator 153 determines whether or not the timer value has reached the threshold value α (Operation St5). When it is determined that the timer value has not reached the threshold value α (“No” in Operation St5), the comparator 153 executes the operation St5 again. When it is determined that the timer value has reached the threshold value α (“Yes” in Operation St5), the comparator 153 outputs an interrupt request to the CPU 130 (Operation St6).

Next, the CPU 130 collects interrupt factor registers from the register holding circuit 159 (Operation St7). The register holding circuit 159 holds interrupt factor registers corresponding to all alarms received during a period from the reception of the first alarm until the timer value reaches the threshold value α. Therefore, the CPU 130 may collectively process the interrupt factor registers of all the alarms within that period.

Next, the CPU 130 makes a determination on path switching based on the interrupt factor register (Operation St8). At this time, the CPU 130 determines a logical path corresponding to the target of switching to the standby system based on, for example, the interrupt factor register, and generates failure path information from a result of the determination. Next, the CPU 130 outputs the failure path information to the switching unit 14 (Operation St9).

Next, based on the failure path information, the switching unit 14 sets the path switching for the corresponding logical line (Operation St10). The path switching operation is performed in this manner.

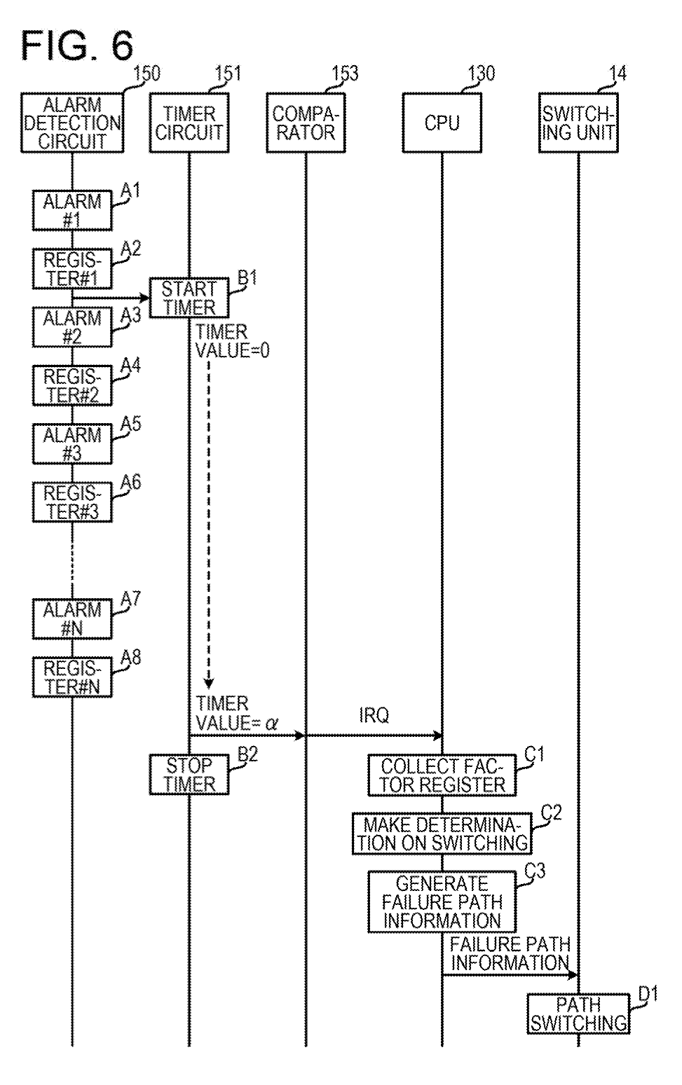

FIG. 6 is a sequence diagram illustrating a path switching operation when there are many alarms, in the first comparative example. In this example, it is assumed that up to N (N: a positive integer) alarms are continuously generated due to the same failure or a plurality of failures related to each other, and the threshold value α of the timer is determined as a standby time expected from a reception time of the N alarms. FIG. 6 illustrates processes of the alarm detection circuit 150, the timer circuit 151, the comparator 153, the CPU 130, and the switching unit 14 in the configuration illustrated in FIG. 4.

The alarm detection circuit 150 receives an alarm #1 (symbol A1) and holds an interrupt factor register #1 (simply referred to as a “register”) for the alarm #1 in the register holding circuit 159 (symbol A2). Next, the alarm detection circuit 150 causes the timer circuit 151 to start the timer (symbol B1). The timer value increases from 0 to the threshold value α, as indicated by a dotted line. In a period during which the timer value increases from 0 to the threshold value α, the alarm detection circuit 150 receives alarms #2 to #N and holds interrupt factor registers #2 to #N for the alarms #2 to #N in the register holding circuit 159 (symbols A3 to A8).

When the timer value reaches the threshold value α, the comparator 153 outputs an IRQ to the CPU 130. When the interrupt request is output, the timer circuit 151 stops the timer (symbol B2).

Upon receiving the interrupt request, the CPU 130 collects the interrupt factor registers #1 to #N from the register holding circuit 159 (symbol C1). Next, the CPU 130 makes a determination on path switching based on the interrupt factor registers #1 to #N (symbol C2), and generates failure path information based on a result of the determination (symbol C3).

Next, the CPU 130 outputs the failure path information to the switching unit 14. The switching unit 14 performs path switching based on the failure path information (symbol D1).

In this manner, since the alarm processing unit 15 stands by for a period until the timer value 0 reaches the threshold value α from 0 and then outputs the interrupt request to the CPU 130, the CPU 130 may execute the path switching process at once based all the alarms #1 to #N received during that period. Therefore, since the number of interrupt requests is reduced as compared with a case where an interrupt request is input for each alarm, the CPU 130 may omit an overhead process accompanying the interrupt, which contributes to reducing a load and shortening the time required for the path switching process.

However, as in the following example, when the number of consecutively generated alarms is less than the number N previously assumed, the alarm processing unit 15 needs to stand by until the standby time elapses even after receiving all the alarms.

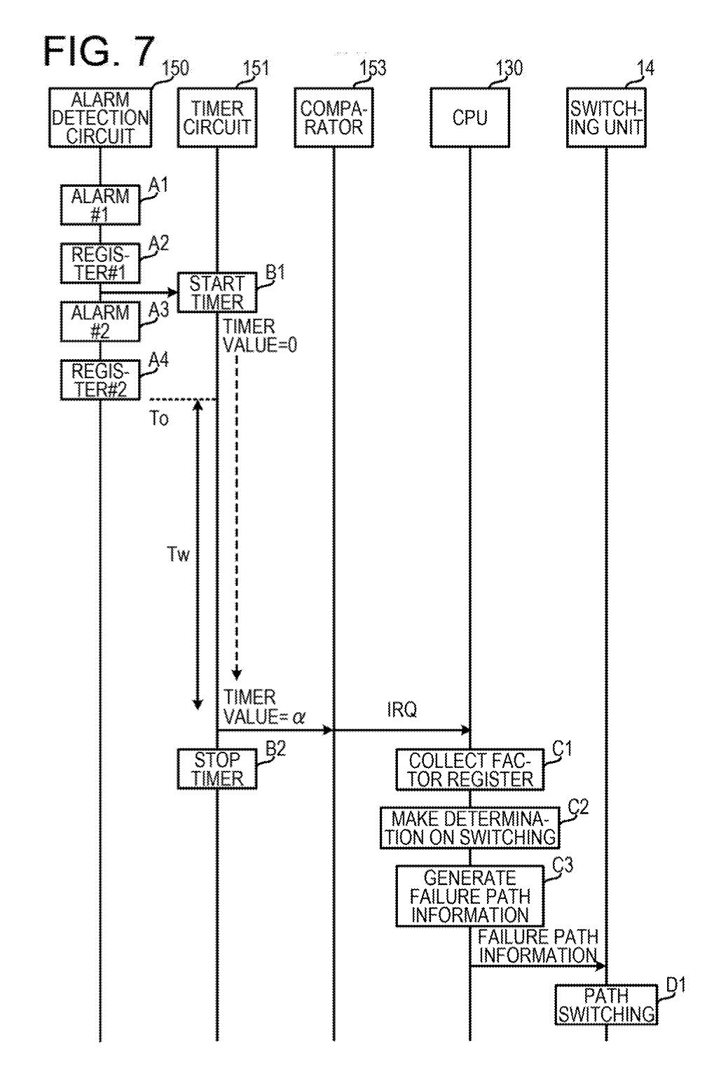

FIG. 7 is a sequence diagram illustrating a path switching operation when there are a few alarms, in the first comparative example. In FIG. 7, the same processes as FIG. 6 are denoted by the same symbols and therefore, explanation of which will be omitted.

In this example, it is assumed that two (<N) alarms are received. The alarm processing unit 15 stands by until the timer value reaches the threshold value α even after receiving all the alarms #1 and #2 (symbols A1 and A3).

Therefore, although the path switching process may be executed at a timing after receiving the alarm #2, it is not actually executed until the timer value reaches the threshold value α. Accordingly, the alarm processing unit 15 has an extra standby time Tw as the number of alarms is smaller.

### Second Comparative Example

In contrast, when the number of alarms received is counted and the count value reaches a threshold value M (M: a positive integer, M<N) or the timer value reaches a threshold value α′ (<α), an interrupt request may be output.

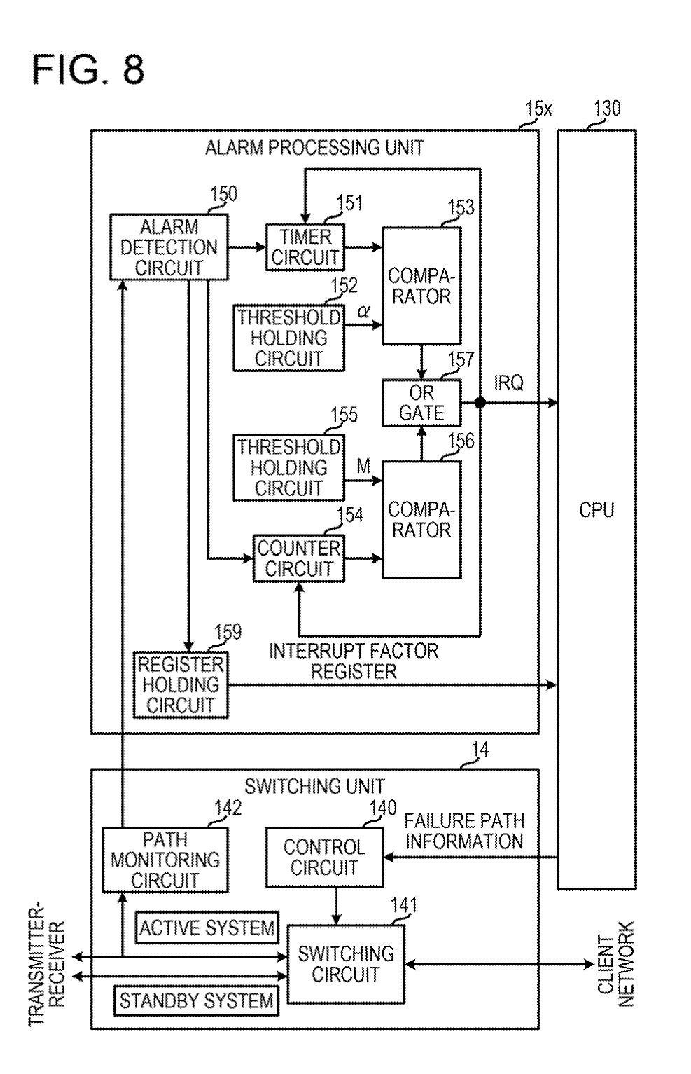

FIG. 8 is a diagram illustrating a configuration related to path switching in a second comparative example. In FIG. 8, the same elements as FIG. 4 are denoted by the same reference numerals and therefore, explanation of which will be omitted. An alarm processing unit 15x is provided in the path control unit 132 and includes an alarm detection circuit 150, a timer circuit 151, threshold holding circuits 152 and 155, comparators 153 and 156, a counter circuit 154, an OR gate 157, and a register holding circuit 159. In the case of the configuration of FIG. 2, the alarm processing unit 15x is provided in the path processing unit 113 of the line IF units 11a and 11b.

The counter circuit 154 counts the number of alarms detected by the alarm detection circuit 150, that is, the number of alarms received, and outputs the count value to the comparator 156. The threshold holding circuit 155 holds a threshold value M of the count value. The threshold holding circuit 155 is configured by, for example, a volatile memory.

The comparator 156 compares the count value with the threshold value M read from the threshold holding circuit 155. As a result of the comparison, when the count value does not match the threshold value M, the comparator 156 outputs a low level voltage signal to the OR gate 157. When the count value matches the threshold value M, the comparator 153 outputs a high level voltage signal to the OR gate 157.

In the meantime, the comparator 153 compares the timer value with the threshold value α′ read from the threshold holding circuit 152. As a result of the comparison, when the timer value does not match the threshold value α′, the comparator 153 outputs a low level voltage signal to the OR gate 157. When the timer value matches the threshold value α′, the comparator 153 outputs a high level voltage signal to the OR gate 157.

The OR gate 157 outputs a signal corresponding to a voltage level of the signal input from each of the comparators 153 and 156, to the CPU 130. More specifically, when at least one of signal voltages input from the comparators 153 and 156 is at a high level, the OR gate 157 outputs a high level voltage signal as an interrupt request to the CPU 130. When both of the signal voltages input from the comparators 153 and 156 are at a low level, the OR gate 157 outputs no interrupt request. That is, the interrupt request is output when the timer value reaches the threshold value α′ or when the count value reaches the threshold value M.

The interrupt request is also input to the timer circuit 151 and the counter circuit 154. The timer circuit 151 and the counter circuit 154 are reset when the interrupt request is input thereto.

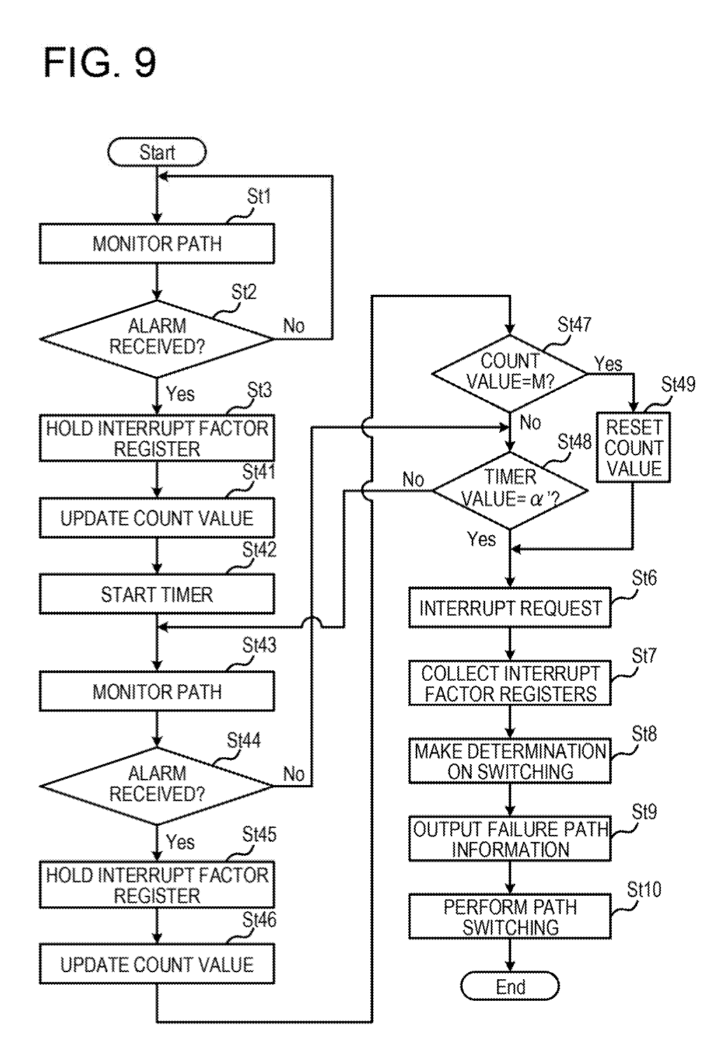

FIG. 9 is a flowchart illustrating a path switching operation in the second comparative example. In FIG. 9, the same operations as FIG. 5 are denoted by the same symbols and therefore, explanation of which will be omitted.

After the alarm detection circuit 150 detects the first alarm #1 and holds the interrupt factor register for the alarm #1 in the register holding circuit 159 (Operation St3), the counter circuit 154 updates the count value (Operation St41). More specifically, the count value is changed from 0 to 1.

Next, the alarm detection circuit 150 causes the timer circuit 151 to start the timer that counts the time of the threshold value α′ (Operation St42). Next, the path monitoring circuit 142 monitors the active path based on a monitoring packet (Operation St43). Next, the alarm detection circuit 150 determines whether or not an alarm is received (Operation St44).

When no alarm is received (No in Operation St44), the alarm detection circuit 150 executes Operation St48 to be described later. When an alarm is received (Yes in Operation St44), the alarm detection circuit 150 holds an interrupt factor register for the alarm in the register holding circuit 159 (Operation St45). Next, the counter circuit 154 updates the count value (Operation St46). More specifically, the counter circuit 154 adds 1 to the count value.

Next, the comparator 156 compares the count value with a threshold value M (Operation St47). When the count value reaches the threshold value M (Yes in Operation St47), the counter circuit 154 resets the count value (Operation St49). Next, the OR gate 157 outputs an interrupt request to the CPU 130 (Operation St6).

When the count value does not reach the threshold value M (No in Operation St47), the comparator 153 compares the timer value with a threshold value α′ (Operation St48). When the timer value does not reach the threshold value α′ (No in Operation St48), Operation St43 is executed again. When the count value reaches the threshold value M (Yes in Operation St47), the OR gate 157 outputs an interrupt request to the CPU 130 (Operation St6). The path switching operation is performed in this manner.

In this way, in this example, when the count value reaches the threshold value M or when the timer value reaches the threshold value α′, an interrupt request is output. Therefore, by appropriately setting the threshold value M, it is possible to reduce the extra standby time when the number of alarms is small. Even when the number of alarms does not reach the threshold value M, it is possible to reduce the extra standby time by appropriately setting the threshold value α′.

However, in this example, the number of alarms that may be processed by the CPU 130 according to one interrupt request is limited to M at most. Therefore, when the number of alarms is greater than M, there is a possibility that the time required for path switching may increase with the increase in the number of interrupt requests.

### Third Comparative Example

In contrast, the alarm processing unit 15 may switch the threshold value of the timer value according to the number of received alarms.

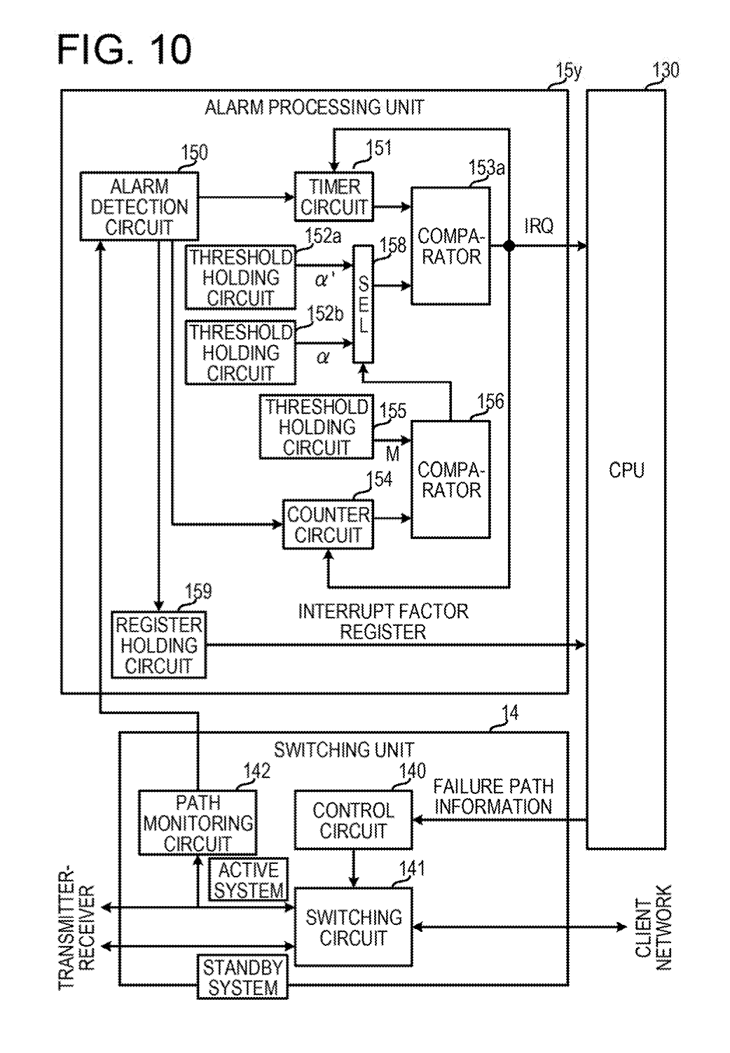

FIG. 10 is a diagram illustrating a configuration related to path switching in a third comparative example. In FIG. 10, the same elements as FIG. 8 are denoted by the same reference numerals and therefore, explanation of which will be omitted. An alarm processing unit 15y is provided in the path control unit 132 and includes an alarm detection circuit 150, a timer circuit 151, threshold holding circuits 152a, 152b, and 155, comparators 153a and 156, a counter circuit 154, a selector (SEL) 158, and a register holding circuit 159. In the case of the configuration of FIG. 2, the alarm processing unit 15y is provided in the path processing unit 113 of the line IF units 11a and 11b.

The threshold holding circuits 152a and 152b is constituted by, for example, a volatile memory. One threshold value α′ of a timer value is held in the threshold holding circuit 152a and the other threshold value α of the timer value is held in the threshold holding circuit 152b. Here, the threshold value α′ is smaller than the threshold value α.

The selector 158 outputs one of the threshold values α′ and α of the threshold holding circuits 152a and 152b to the comparator 153a according to a signal voltage input from the comparator 156. More specifically, when the signal voltage of the comparator 156 is at a low level, the threshold value α′ is output from the threshold holding circuit 152a to the comparator 153a and, when the signal voltage of the comparator 156 is at a high level, the threshold value α′ is output from the threshold holding circuit 152b to the comparator 153a. The comparator 156 holds the signal voltage at a high level, for example, by a latch circuit.

Therefore, the comparator 153a uses the threshold value α′ when the count value does not reach the threshold value M, and uses the threshold value α after the count value reaches the threshold value M. That is, the threshold value of the timer value is switched by the count value.

The comparator 153a outputs an IRQ to the CPU 130 when the timer value reaches the threshold value α or α′ input from the selector 158.

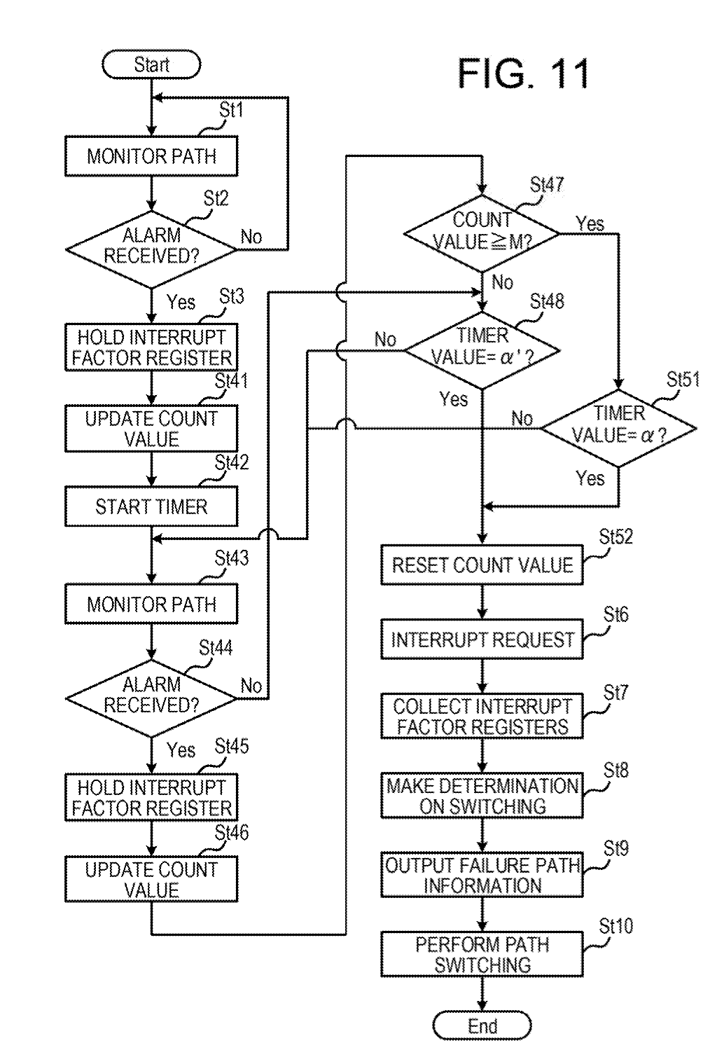

FIG. 11 is a flowchart illustrating a path switching operation in the third comparative example. In FIG. 11, the same processes as FIG. 9 are denoted by the same symbols and therefore, explanation of which will be omitted.

After the updating of the count value (Operation St46), when it is determined that the count value does not reach the threshold value M (“No” in Operation St47), the comparator 153a compares the timer value with the threshold value α′ (Operation St48). When it is determined that the timer value does not match the threshold value α′ (“No” in Operation St48), Operation St43 is executed. When it is determined that the timer value matches the threshold value α′ (“Yes” in Operation St48), the comparator 153a resets the count value (Operation St52) and outputs an interrupt request to the CPU 130 (Operation St 6).

When it is determined that the count value is equal to or larger than the threshold value M (“Yes” in Operation St47), the comparator 153a compares the timer value with the threshold value α (Operation St51). When it is determined that the timer value does not match the threshold value α (“No” in Operation St51), Operation St43 is executed. When it is determined that the timer value matches the threshold value α (“Yes” in Operation St51), the comparator 153a resets the count value (Operation St52) and outputs an interrupt request to the CPU 130 (Operation St6). The path switching operation is performed in this manner.

In this way, in this example, when the count value exceeds the threshold value M, the threshold value of the timer value is extended from α′ to a. Therefore, when the number of alarms is equal to or larger than M, since the standby time is extended, the CPU 130 may process M or more alarms according to one interrupt request, thereby shortening the time required for path switching.

However, in this example, since an interrupt request is output after the timer value reaches the threshold value α or the threshold value α′, there is a possibility that an extra standby time may increase depending on the threshold values α and α′ when the number of alarms is small.

### First Embodiment

In order to avoid the problems mentioned in the above-described first to third comparative examples, in a path switching method according to a first embodiment, when the last alarm of a series of alarms received at a time interval equal to or less than a predetermined value is received, interruption requests for logical paths corresponding to the series of alarms are collectively output to the CPU 130. Therefore, for example, after completion of reception of a series of alarms successively occurring due to the same failure or a plurality of failures related to each other, interruption requests for logical paths corresponding to all the alarms may be collectively output to the CPU 130. Accordingly, the load on the CPU 130 is reduced and path switching is executed at an appropriate timing.

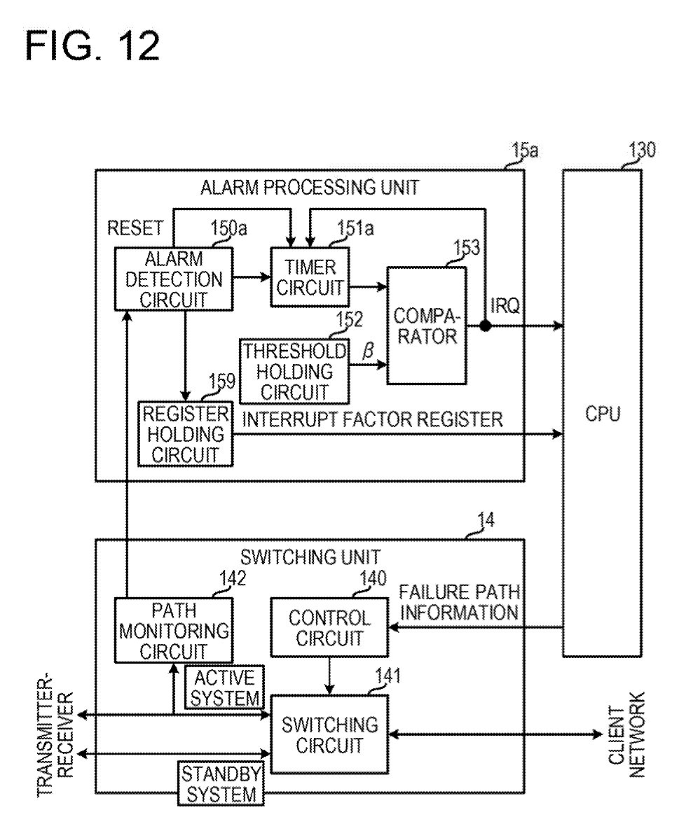

FIG. 12 is a diagram illustrating a configuration related to path switching in the first embodiment. In FIG. 12, the same elements as FIG. 4 are denoted by the same reference numerals and therefore, explanation of which will be omitted. An alarm processing unit 15a is an example of a request unit, receives an alarm of the active path from the switching unit 14, and outputs an interrupt request to the CPU 130 to request that the CPU 130 perform a switching operation based on the received alarm.

The alarm processing unit 15a is provided in the path control unit 132 and includes an alarm detection circuit 150a, a timer circuit 151a, a threshold holding circuit 152, a comparator 153, and a register holding circuit 159. In the case of the configuration of FIG. 2, the alarm processing unit 15a is provided in the path processing unit 113 of the line IF units 11a and 11b.

The alarm detection circuit 150a detects an alarm by receiving information on the status of the active path from the path monitoring circuit 142. That is, the alarm detection circuit 150a receives an alarm of the active path. For example, the alarm detection circuit 150a holds information such as a logical path corresponding to the alarm, as an interrupt factor register, in the register holding circuit 159.

After initiating the reception of alarm, the alarm processing unit 15a recognizes an alarm received within a threshold value β from the reception of the previous alarm, as an alarm related to the previous alarm. That is, the alarm processing unit 15a recognizes a series of alarms received at a time interval equal to or less than the threshold value β. After completion of reception of the last alarm of the series of alarms, the alarm processing unit 15a collectively outputs interrupt requests to the CPU 130 for logical paths corresponding to the series of alarms. The operation of the alarm processing unit 15a will be described below.

After detection of the first alarm of the alarms occurred consecutively due to the same failure or a plurality of failures related to each other, the alarm detection circuit 150a instructs the timer circuit 151a to start a timer that counts the time of the threshold value β. The timer circuit 151a starts the timer (that is, initiates counting) according to the instruction from the alarm detection circuit 150a and outputs the timer value to the comparator 153. A predetermined threshold value β (<α and α′) is held in the threshold holding circuit 152. The comparator 153 reads the threshold value β, as a value at the expiration of the timer, from the threshold holding circuit 152.

The comparator 153 compares the timer value input from the timer circuit 151a with the threshold value β read from the threshold holding circuit 152. As a result of the comparison, when the timer value does not match the threshold value β, the comparator 153 outputs a low level voltage signal to the CPU 130. When the timer value matches the threshold value β, the comparator 153 outputs a high level signal voltage, an IRQ, to the CPU 130.

The alarm detection circuit 150a resets the timer value of the timer circuit 151a to 0 each time an alarm is detected after detection of the first alarm. Therefore, while the alarm reception interval is shorter than the threshold value β, the expiration time of the timer is substantially extended. The timer circuit 151a continues the counting by the timer even after the timer is reset.

Accordingly, the alarm processing unit 15a recognizes the alarm received within the predetermined time (threshold value β) from the reception of the previous alarm, as an alarm related to the previous alarm. As a result, the alarm processing unit 15a may receive a series of alarms that occur consecutively due to, for example, the same failure or a plurality of failures related to each other.

The comparator 153 outputs an interrupt request to the CPU 130 when the timer value reaches the threshold value β. That is, when the reception interval of the alarm becomes equal to or larger than the threshold value β, the alarm processing unit 15a determines that the reception of the last alarm (the alarm having the latest reception time) among the above series of alarms has ended, and collectively outputs interrupt requests for logical paths corresponding to the received series of alarms to the CPU 130.

In this way, when initiating the reception of alarm, the alarm processing unit 15a starts a timer that counts the time of the threshold value β, resets the timer each time an alarm is received, and outputs an interrupt request to the CPU 130 when the timer expires. Accordingly, the alarm processing unit 15a may control the timing of the interrupt request with high accuracy based on the timer.

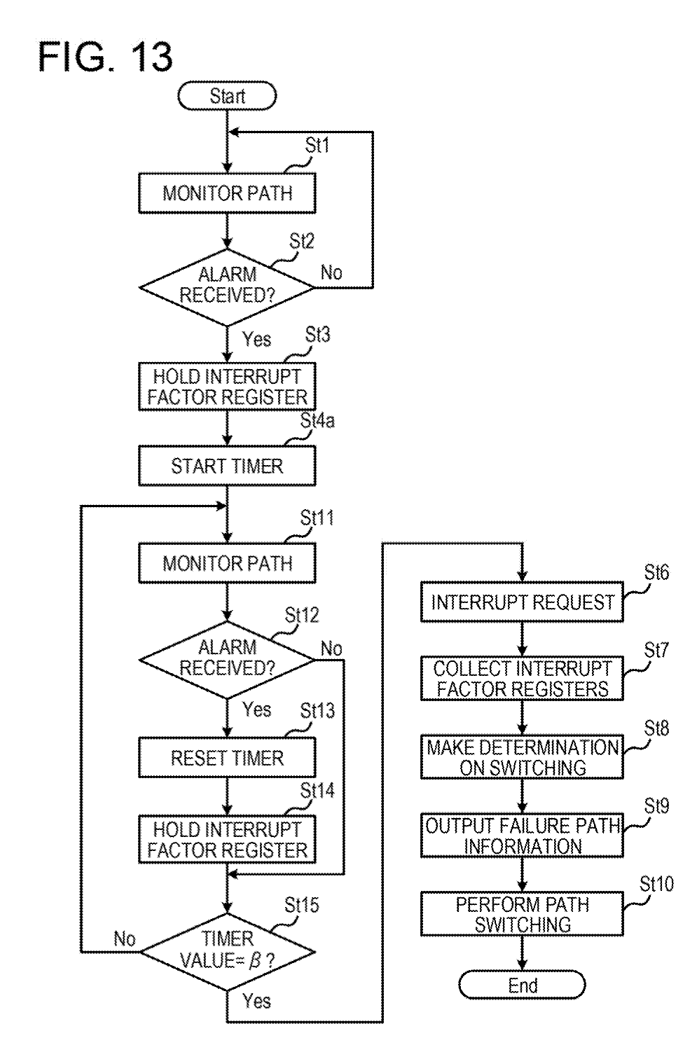

FIG. 13 is a flowchart illustrating a path switching operation in the first embodiment. In FIG. 13, the same operations as FIG. 5 are denoted by the same symbols and therefore, explanation of which will be omitted.

After reception of the first alarm (Operations St2 and St3), the timer circuit 151 starts the timer that counts the time of the threshold value β (Operation St4a). That is, the timer circuit 151a starts the timer in response to the reception of the first alarm of a series of alarms that occur due to the same failure or a plurality of failures related to each other.

Next, the path monitoring circuit 142 monitors the active path based on a monitoring packet (Operation St11). The alarm detection circuit 150a determines whether or not an alarm is received (Operation St12). When it is determined that no alarm is received (“No” in Operation St12), the timer circuit 151a determines whether or not the timer value reaches the threshold value β (Operation St15).

When it is determined that the timer value does not reach the threshold value β (“No” in Operation St15), Operation St11 is executed again. When it is determined that the timer value reaches the threshold value β (“Yes” in Operation St15), the comparator 153 outputs an interrupt request (Operation St6). That is, when the timer expires, the alarm processing unit 15a recognizes the end of reception of the last alarm of the series of alarms and outputs an interrupt request.

When it is determined that an alarm is received (“Yes” in Operation St12), the alarm detection circuit 150a resets the timer value of the timer circuit 151a to 0 (Operation St13). Next, the alarm detection circuit 150a holds an interrupt factor register for the alarm in the register holding circuit 159 (Operation St14). Thereafter, Operation St15 is executed. In this manner, the path switching operation is executed.

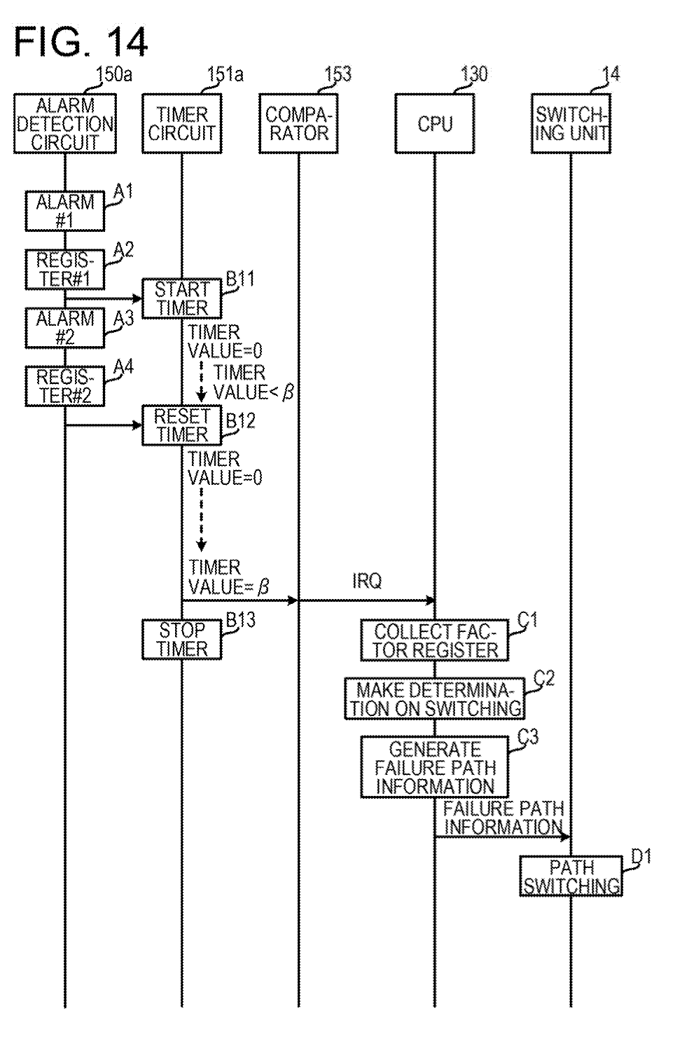

FIG. 14 is a sequence diagram illustrating the path switching operation in the first embodiment. In FIG. 14, the same processes as FIG. 7 are denoted by the same symbols and therefore, explanation of which will be omitted. This example represents a case where two alarms are received, but even when the number of alarms is two or more, the process described below is executed in the same way.

After receiving a first alarm #1, the alarm detection circuit 150a starts the timer of the timer circuit 151a (symbol B11). That is, the timer circuit 151a starts the timer upon reception of the first alarm #1 of a series of alarms that occur due to the same failure or a plurality of failures related to each other.

The timer value increases from 0, as indicated by a dotted line. The alarm detection circuit 150a resets the timer value of the timer circuit 151a (symbol B12) after receiving an alarm #2. At this time, since the timer value has not reached the threshold value β (timer value <β), the timer value is returned to 0.

Thereafter, since no alarm is received, the timer value increases to the threshold value β, as indicated by a dotted line. When the timer value reaches the threshold value β, the timer is stopped (symbol B13) and the comparator 153 outputs an interrupt request to the CPU 130. That is, upon expiration of the timer, the alarm processing unit 15a recognizes that the reception of the last alarm of the series of alarms received at a time interval equal to or less than the threshold value β has ended, and outputs an interrupt request to the CPU 130.

In this way, in this example, the alarm processing unit 15a receives an alarm for each logical path and, upon receiving the last alarm of the series of alarms received at the time interval equal to or less than the threshold value β, collectively outputs interrupt requests for logical paths corresponding to the series of alarms to the CPU 130. Therefore, since the alarm processing unit 15a collectively outputs interrupt requests at one time based on the series of alarms continuously received at a reception interval within a predetermined value, the load of the path switching process of the CPU 130 may be reduced and the path switching may be performed at an appropriate timing irrespective of the number of alarms.

### Second Embodiment

In the first embodiment, the alarm processing unit 15a outputs an interrupt request in response to the completion of reception of the series of alarms. However, for example, the alarm processing unit 15a may count the number of series of alarms and output an interrupt request when the count value reaches a predetermined number. Thus, for example, since the upper limit number of alarms processed by the CPU 130 with one interrupt request may be set, the load of the path switching process of the CPU 130 may be suppressed.

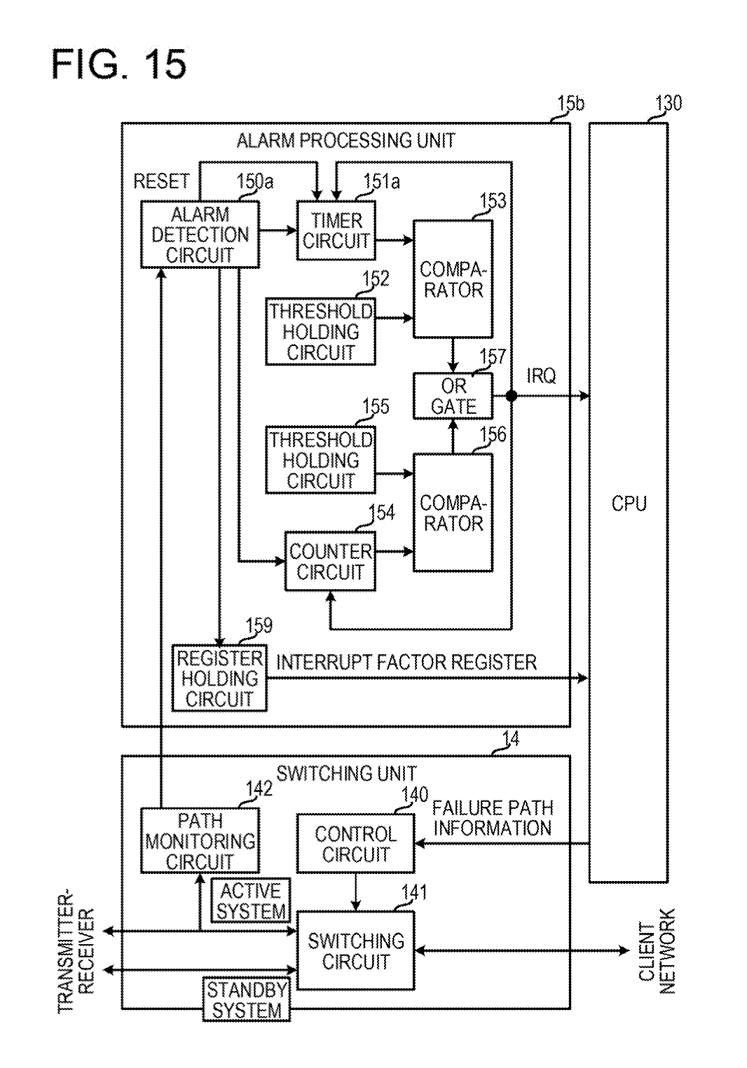

FIG. 15 is a diagram illustrating a configuration related to path switching in the second embodiment. In FIG. 15, the same elements as FIGS. 8 and 12 are denoted by the same reference numerals and therefore, explanation of which will be omitted. In a path switching method of this embodiment, as in the first embodiment, an interrupt request is output when the timer value reaches the threshold value β, and, as in the second comparative example, the number of alarms is counted and an interrupt request is output when the count value reaches a threshold value M.

An alarm processing unit 15b is an example of a request unit, receives an alarm of the active path from the switching unit 14, and outputs an interrupt request to the CPU 130 to request that the CPU 130 perform a switching operation based on the received alarm. The alarm processing unit 15b is provided in the path control unit 132 and includes an alarm detection circuit 150a, a timer circuit 151a, threshold holding circuits 152 and 155, comparators 153 and 156, a counter circuit 154, an OR gate 157, and a register holding circuit 159. In the case of the configuration of FIG. 2, the alarm processing unit 15b is provided in the path processing unit 113 of the line IF units 11a and 11b.

The counter circuit 154 counts the number of alarms received by the alarm detection circuit 150a at a time interval equal to or less than a threshold value β and outputs the count value to the comparator 156. After the count value reaches the threshold value M, the counter circuit 154 resets the count value by an interrupt request signal and stops the counting.

The comparator 156 compares the count value with the threshold value M read from the threshold holding circuit 155. As a result of the comparison, when the count value does not match the threshold value M, the comparator 156 outputs a low level voltage signal to the OR gate 157. When the count value matches the threshold value M, the comparator 156 outputs a high level voltage signal to the OR gate 157.

In the meantime, the comparator 153 compares the timer value with the threshold value β read from the threshold holding circuit 152. As a result of the comparison, when the timer value does not match the threshold value β, the comparator 153 outputs a low level voltage signal to the OR gate 157. When the timer value matches the threshold value β, the comparator 153 outputs a high level voltage signal to the OR gate 157.

The OR gate 157 outputs a signal corresponding to a voltage level of the signal input from each of the comparators 153 and 156, to the CPU 130. More specifically, when at least one of signal voltages input from the comparators 153 and 156 is at a high level, the OR gate 157 outputs a high level voltage signal as an interrupt request to the CPU 130. When both of the signal voltages input from the comparators 153 and 156 are at a low level, the OR gate 157 outputs no interrupt request. That is, the interrupt request is output when the timer value reaches the threshold value β or when the count value reaches the threshold value M.

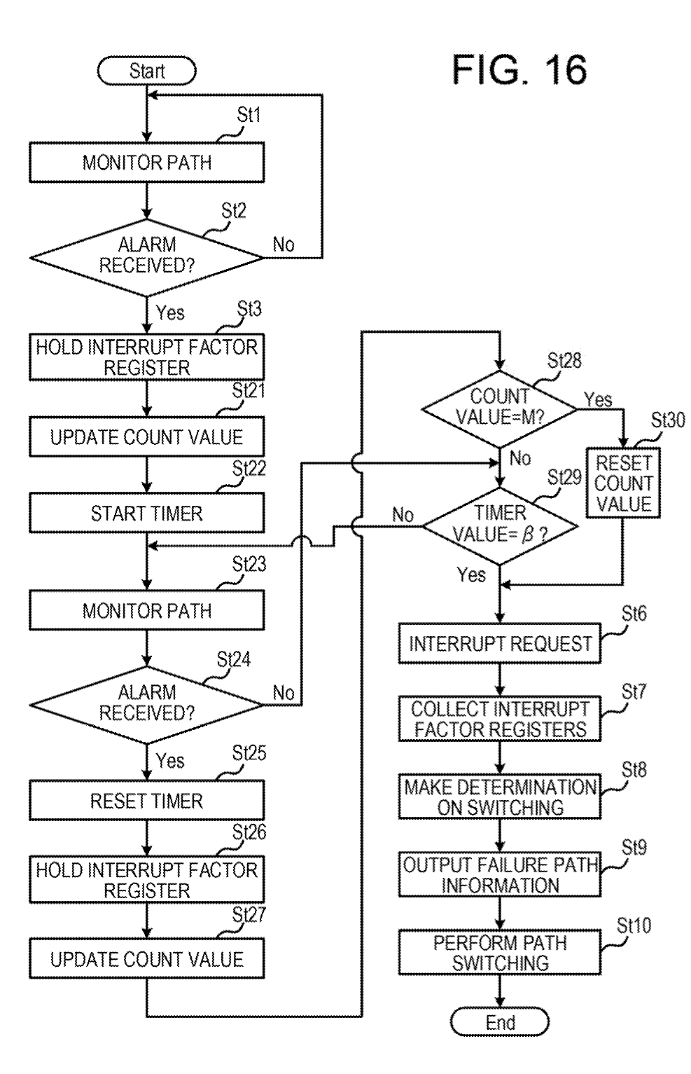

FIG. 16 is a flowchart illustrating a path switching operation in the second embodiment. In FIG. 16, the same operations as FIG. 5 are denoted by the same symbols and therefore, explanation of which will be omitted.

When it is determined that the first alarm is received (“Yes” in Operation St2), the alarm detection circuit 150a holds an interrupt factor register in the register holding circuit 159 (Operation St3). Next, the counter circuit 154 updates the count value (Operation St21). More specifically, the counter circuit 154 sets the count value to 1.

Next, the alarm detection circuit 150a causes the timer circuit 151a to start a timer that counts the time of the threshold value β (Operation St22). That is, the timer circuit 151a starts the timer in response to the reception of the first alarm of a series of alarms that occur due to the same failure or a plurality of failures related to each other.

Next, the path monitoring circuit 142 monitors the active path based on a monitoring packet (Operation St23). The alarm detection circuit 150a determines whether or not an alarm is received (Operation St24). When no alarm is received (No in Operation St24), the timer circuit 151a determines whether or not the timer value reaches the threshold value β (Operation St29).

When it is determined that the timer value does not reach the threshold value β (“No” in Operation St29), Operation St23 is executed. When the timer value reaches the threshold value β (Yes in Operation St29), the comparator 153 outputs an interrupt request (Operation St6). That is, when the timer expires, the alarm processing unit 15b recognizes the end of the reception of the last alarm of the series of alarms and outputs an interrupt request.

When it is determined that an alarm is received (“Yes” in Operation St24), the alarm detection circuit 150a resets the timer value of the timer circuit 151a to 0 (Operation St25). Next, the alarm detection circuit 150a holds an interrupt factor register for the alarm in the register holding circuit 159 (Operation St26).

Next, the counter circuit 154 updates the count value (Operation St27). More specifically, the counter circuit 154 adds 1 to the count value.

Next, the comparator 156 determines whether or not the count value reaches the threshold value M (Operation St28). When it is determined that the count value does not reach the threshold value M (“No” in Operation St28), Operation St29 is executed.

When it is determined that the count value reaches the threshold value M (“Yes” in Operation St28), the counter circuit 154 resets the count value in response to an interrupt request signal input from the OR gate 157 (Operation St30). As a result, the counter circuit 154 stops the counting. Therefore, since no interrupt request is issued to the CPU 130 thereafter, the load of the path switching process of the CPU 130 is reduced.

Next, the OR gate 157 outputs an interrupt request (Operation St6). That is, when the count value reaches the threshold value M, the alarm processing unit 15b outputs an interrupt request. The Operation St6 and Operation St30 are executed substantially at the same time. Thereafter, Operation St7 is executed. In this manner, the path switching operation is executed.

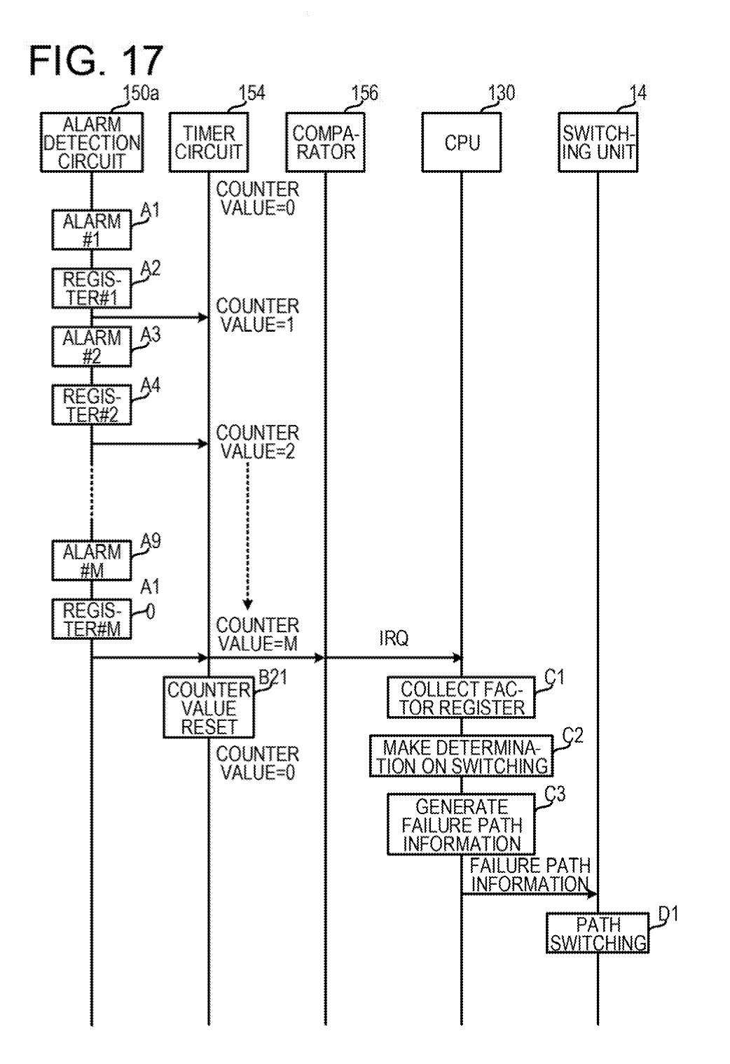

FIG. 17 is a sequence diagram illustrating the path switching operation in the second embodiment. In FIG. 17, the same processes as FIG. 14 are denoted by the same symbols and therefore, explanation of which will be omitted. This example represents a case where an interrupt request is output when the count value reaches the threshold value M. Therefore, in FIG. 17, unlike FIG. 14, a counter circuit 154 is illustrated instead of the timer circuit 151a.

When an alarm #1 is received (symbol A1), the counter circuit 154 updates the count value from 0 to 1. When an alarm #2 is received (symbol A3), the counter circuit 154 updates the count value from 1 to 2. Thereafter, when an alarm #M is received (symbol A9), the counter circuit 154 sets the count value as M. Upon receiving the alarm #M, the alarm detection circuit 150a holds an interrupt factor register for the alarm #M in the register holding circuit 159 (symbol A10).

When the count value becomes M, the comparator 156 outputs an interrupt request to the CPU 130 via the OR gate 157. In addition, the counter circuit 154 resets the count value to 0 (symbol B21) in response to an interrupt request signal and stops the alarm counting. Accordingly, the alarm processing unit 15b stops the subsequent interrupt requests. Therefore, an increase in the load of the path switching process of the CPU 130 due to further interruption request is suppressed.

In this way, the alarm processing unit 15b counts the number of series of alarms received at a time interval equal to or less than the threshold value β and, when the count value reaches the threshold value M, collectively outputs interrupt requests for logical paths corresponding to the series of alarms to the CPU 130. Therefore, the number of alarms processed by the CPU 130 according to one interruption request is limited to M.

Therefore, by appropriately setting the threshold value M depending on the performance of the CPU 130, it is possible to reduce the load of the path switching process of the CPU 130. For example, if the number of series of alarms is 512, when the threshold value M is set to 256, the CPU 130 may process 256 alarms according to two interrupt requests.

The above-described embodiments are just illustrative. However, the present disclosure is not limited thereto, but various modifications can be made without departing from the spirit and scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a hardware processor configured to receive an alarm for each of paths, and generate an interrupt request, when a series of alarms is received at a time interval equal to or less than a predetermined value and a last alarm of the series of alarms is received;
a memory; and
a processor coupled to the memory and the processor configured to switch the path, provided on a transmission line in an active system and from which the alarm is received, from the active system to a standby system in response to the interrupt request generated by the hardware processor.

2. The transmission device according to claim 1, wherein the hardware processor is configured to:
start a timer that counts the predetermined value when a first alarm of the series of alarms is received,
reset the timer each time when a second alarm of the series of alarms is received, and
generate the interrupt request when the timer counts the predetermined value.

3. A transmission device comprising:
a hardware processor configured to receive an alarm for each of paths, count a number of received alarms, and generate an interrupt request when the counted number of received alarms reaches a predetermined number;
a memory; and
a processor coupled to the memory and the processor configured to switch the path, provided on a transmission line in an active system and from which the alarm is received, from the active system to a standby system in response to the interrupt request generated by the hardware processor.

4. The transmission device according to claim 3, wherein the hardware processor is configured to stop counting the number of received alarms when the counted number of received alarms reaches the predetermined number.

5. A path switching method comprising:
receiving an alarm for each of paths, by a hardware processor;
generating an interrupt request based on a plurality of alarms from the paths, by the hardware processor;
switching the path, provided on a transmission line in an active system and from which the alarm is received, from the active system to a standby system in response to the interrupt request generated by the hardware processor, by a processor.

6. The path switching method according to claim 5,
wherein the hardware processor generates the interrupt request, when a series of alarms is received at a time interval equal to or less than a predetermined value and a last alarm of the series of alarms is received.

7. The path switching method according to claim 6,
wherein the hardware processor:
starts a timer that counts the predetermined value when a first alarm of the series of alarms is received,
resets the timer each time when a second alarm of the series of alarms is received, and
generates the interrupt request when the timer counts the predetermined value.

8. The path switching method according to claim 5,
wherein the hardware processor counts a number of received alarms, and generates the interrupt request when the counted number of received alarms reaches a predetermined number.

9. The path switching method according to claim 8,
wherein the hardware processor stops counting the number of received alarms when the counted number of received alarms reaches the predetermined number.
